(19) United States
(12) Patent Application Publication
(10) Pub. No.: US 2026/0319135 A1
(43) Pub. Date: Oct. 15, 2026

(54) PARTIALLY PERFORATED FILM

(71) Applicant: Shenzhen Lifengda Technology Co., Ltd, Shenzhen (CN)

(72) Inventors: Hongxuan DENG, Shenzhen (CN); Xin TENG, Shenzhen (CN)

(21) Appl. No.: 19/218,326

(22) Filed: May 25, 2025

(30) Foreign Application Priority Data
Apr. 14, 2025 (CN) 202520708748.0

(51) Int. Cl. G02B 1/11

(52) U.S. Cl. CPC G02B 1/11

(57) ABSTRACT

The present utility model discloses a partially perforated film, including an intermediate functional layer, and substrate layers closely attached to upper and lower surfaces of the functional layer, the functional layer being provided with a perforated hole corresponding to a front-facing camera and an optical controller of a device, and the perforated hole being filled with transparent glue which is pressed by the substrate layers at the upper and lower surfaces to form a light-transmitting layer. According to the technical solutions of the present utility model, the normal functionality of the front-facing camera is achieved by filling a through hole in an anti-peep, anti-blue light or other functional layer with the transparent glue to from a transparent layer.

### TECHNICAL FIELD

The present utility model relates to the technical field of display auxiliary devices, and in particular, to a partially perforated film.

### BACKGROUND

Electronic devices such as mobile phones and tablets have become widely popular, and their screen display quality is getting better and better, resulting in diversified screen protective films. A screen protective film can not only play a physical protective role on a screen, but also have functions of eye protection and ultraviolet protection. Electronic devices such as mobile phones and tablets are generally provided with front-facing cameras. When a protective film with certain functions is attached to the screen of the mobile phone and the tablet, the front-facing camera will be blocked or even completely shielded. Currently, the common solution is to make a hole in the film. However, this approach presents the following problems: firstly, the protective film is visually unappealing, and secondly, dust tends to accumulate in the hole during use after hole making. Therefore, the challenge lies in how to ensure both attractiveness and normal functionality of the front-facing camera.

### SUMMARY

The present utility model aims to provide a partially perforated film, to solve the problems proposed in the background.

To achieve the objective described above, the present utility model provides the following technical solution:
a partially perforated film, including an intermediate functional layer, and substrate layers closely attached to upper and lower surfaces of the functional layer, the functional layer being provided with a perforated hole corresponding to a front-facing camera and an optical controller of a device, and the perforated hole being filled with transparent glue which is pressed by the substrate layers at the upper and lower surfaces to form a light-transmitting layer.

In a further example, the functional layer may, as needed, be an anti-peep layer, an anti-blue light layer, a high-reflection layer, an infrared light shielding layer, a grating layer, a polarizing layer, a UV light shielding layer, a PDLC dimming film, or a structured light layer.

In a further example, the substrate layers at the upper and lower surfaces may, as needed, be made of PET, PC, PMMA, TAC, SRF, glass, PI, PEN, nylon, TPU, or PU.

In a further example, upper and lower surfaces of the light-transmitting layer are respectively flush with the upper and lower surfaces of the functional layer and are closely attached to the substrate layers at the upper and lower surfaces.

In a further example, a magnetic layer is provided around an edge of each substrate layer and is closely attached and fixed to an edge of a screen.

In a further example, a soft resin layer is fixed on a frame at a bottom surface of the lower substrate layer and is arranged in a strip shape along an edge of the frame of the substrate layer to form a frame attachment structure, an adhesive layer for adhesion and fixing is provided between the soft resin layer and the substrate layer, and the soft resin layer under pressure is closely attached to a surface of a screen and forms a pressure-attached connection fixing structure between the soft resin layer and the surface of the screen.

In a further example, the lower substrate layer is coated with glue, facilitating close attachment to a surface of a screen of a display.

In a further example, the lower substrate layer is also coated with automatic exhaust silica gel which facilitate close attachment of the glue to the surface of the screen of the display, enabling free removal and close attachment for multiple times.

Compared with the prior art, the present utility model has the following advantageous effects: the normal functionality of the front-facing camera is achieved by filling a through hole in an anti-peep, anti-blue light or other functional layer with the transparent glue to form a transparent layer. The transparent layer is closely and consistently attached to the upper and lower substrate layers, ensuring high process requirements while maintaining both attractiveness and practicality.

### BRIEF DESCRIPTION OF THE DRAWINGS

FIG. 1 is an overall structural schematic diagram of the present disclosure.

In the figure: 1. substrate layer; 2. functional layer; 3. light-transmitting layer.

### DETAILED DESCRIPTION OF THE EMBODIMENTS

In the description of the present utility model, it should be noted that, unless otherwise explicitly specified or defined, the terms “mounted,” “connected” and “connection” should be understood in a broad sense. For example, these terms may refer to fixed connection, detachable connection, or integrated connection, they may refer to mechanical connection, or electrical connection, and they may refer to direct connection, or indirect connection through an intermediate medium, and may also refer to internal communication between two components. Those of ordinary skill in the art can understand the specific meanings of the above terms in the present utility model according to specific situations.

Technical solutions in the examples of the present utility will be clearly and completely described below with reference to the accompanying drawings in the examples of the present utility model. Obviously, the examples described are merely part of, rather than all the examples of the present utility model. Based on the examples of the present utility model, all other examples obtained by those of ordinary skill in the art without any creative work shall fall within the protection scope of the present utility model.

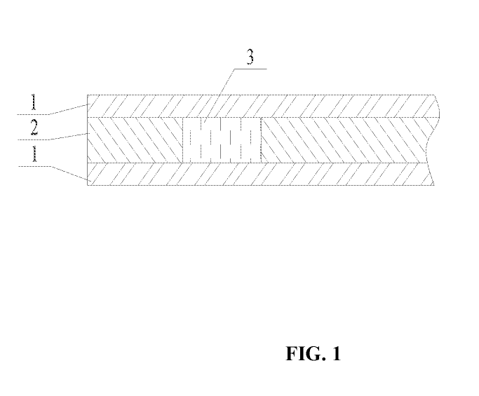

As shown in FIG. 1, the present application provides a partially perforated film, including an intermediate functional layer 2, and substrate layers 1 closely attached to upper and lower surfaces of the functional layer 2, the functional layer 2 being provided with a perforated hole corresponding to a front-facing camera and an optical controller of a device, and the perforated hole being filled with transparent glue which is pressed by the substrate layers at the upper and lower surfaces to form a light-transmitting layer 3.

The functional layer 2 may, as needed, be an anti-peep layer, an anti-blue light layer, a high-reflection layer, an infrared light shielding layer, a grating layer, a polarizing layer, an ultraviolet light shielding (UV) layer, a polymer dispersed liquid crystal (PDLC) dimming film, or a structured light layer. The substrate layers 1 at the upper and lower surfaces may, as needed, be made of polyethylene terephthalate (PET), polycarbonate (PC), polymethyl methacrylate (PMMA), tri-cellulose acetate (TAC), super retardation film (SRF), glass, polyimide (PI), polyethylene naphthalate (PEN), nylon, thermoplastic polyurethane elastomer (TPU), or polyurethane (PU).

Upper and lower surfaces of the light-transmitting layer 3 are respectively flush with the upper and lower surfaces of the functional layer 2 and are closely attached to the substrate layers 1 at the upper and lower surfaces.

Example 1 of the present utility model is as follows: a magnetic layer is provided around an edge of each substrate layer 1 and is closely attached and fixed to an edge of a screen. According to this embodiment, the whole film can be closely attached to a surface of the screen through the magnetic layer rather than being adhered once permanently, facilitating removal or replacement.

Example 2 of the present disclosure is as follows: a soft resin layer is fixed on a frame at a bottom surface of the lower substrate layer and is arranged in a strip shape along an edge of the frame of the substrate layer to form a frame attachment structure, an adhesive layer for adhesion and fixing is provided between the soft resin layer and the substrate layer, and the soft resin layer under pressure is closely attached to a surface of a screen and forms a pressure-attached connection fixing structure between the soft resin layer and the surface of the screen.

Example 3 of the present disclosure is as follows: the lower substrate layer is coated with glue, facilitating close attachment to a surface of a screen of a display. The lower substrate layer can also be coated with automatic exhaust silica gel which facilitates close attachment of the glue to the surface of the screen of the display, enabling free removal and close attachment for multiple times.

An actual use scenario of the present utility model is as follows: in a case where the film is provided with a grating, the current solution is to only make a hole (which must be a through hole) in the film to ensure the normal operation of the front-facing camera. According to the technical solution of the present application, in practical application, the substrate of the anti-peep layer is firstly perforated to make a hole, and then the substrate layer at the bottom is attached to the hole. After attachment, the perforated hole is filled with transparent glue, which requires a process that ensures both smoothness and the absence of bubbles as unevenness or bubbles would severely affect the functionality of the front-facing camera. Finally, the substrate layer at the surface is attached.

It is obvious to those skilled in the art that the present utility model is not limited to the details of the above exemplary examples, and that the present utility model can be implemented in other specific forms without departing from the spirit or basic features of the present utility model. Therefore, the examples should be regarded as exemplary and non-limiting in every respect. The scope of the present utility model is defined by the appended claims rather than by the above description. Therefore, all modifications falling within the meaning and scope of equivalent elements of the claims are intended to be included in the present utility model. Any reference signs in the claims are not to be construed as limiting the claims involved.

In addition, it should be understood that although the present specification is described according to the embodiments, each embodiment does not include merely one independent technical solution. The narration mode of the specification is merely for the sake of clarity. Those skilled in the art shall regard the specification as a whole. The technical solutions of various examples can also be appropriately combined to form other embodiments that can be understood by those skilled in the art.

What is claimed is:

1. A partially perforated film, comprising: an intermediate functional layer, and substrate layers closely attached to upper and lower surfaces of the functional layer, the functional layer being provided with a perforated hole corresponding to a front-facing camera and an optical controller of a device, and the perforated hole being filled with the transparent glue which is pressed by the substrate layers at the upper and lower surfaces to form a light-transmitting layer.

2. The partially perforated film according to claim 1, wherein the functional layer may, as needed, be an anti-peep layer, an anti-blue light layer, a high-reflection layer, an infrared light shielding layer, a grating layer, a polarizing layer, a UV light shielding layer, a PDLC dimming film, or a structured light layer.

3. The partially perforated film according to claim 1, wherein the substrate layers at the upper and lower surfaces may, as needed, be made of PET, PC, PMMA, TAC, SRF, glass, PI, PEN, nylon, TPU, or PU.

4. The partially perforated film according to claim 1, wherein upper and lower surfaces of the light-transmitting layer are respectively flush with the upper and lower surfaces of the functional layer and are closely attached to the substrate layers at the upper and lower surfaces.

5. The partially perforated film according to claim 1, wherein a magnetic layer is provided around an edge of each substrate layer and is closely attached and fixed to an edge of a screen.

6. The partially perforated film according to claim 1, wherein a soft resin layer is fixed on a frame at a bottom surface of the lower substrate layer and is arranged in a strip shape along an edge of the frame of the substrate layer to form a frame attachment structure, an adhesive layer for adhesion and fixing is provided between the soft resin layer and the substrate layer, and the soft resin layer under pressure is closely attached to a surface of a screen and forms a pressure-attached connection fixing structure between the soft resin layer and the surface of the screen.

7. The partially perforated film according to claim 1, wherein the lower substrate layer is coated with glue, facilitating close attachment to a surface of a screen of a display.

8. The partially perforated film according to claim 7, wherein the lower substrate layer is also coated with automatic exhaust silica gel which facilitate close attachment of the glue to the surface of the screen of the display, enabling free removal and close attachment for multiple times.
